(19) United States
(12) Patent Application Publication
(10) Pub. No.: US 2003/0102689 A1
(43) Pub. Date: Jun. 5, 2003

(54) Stroller weather shield having see-through window

(76) Inventor: Sung Bum Cho, Kimpo-shi (JP)

Correspondence Address: SANTANGELO LAW OFFICES, P.C., 125 SOUTH HOWES, THIRD FLOOR, FORT COLLINS, CO, 80521, US

(21) Appl. No.: 10/220,784

(22) PCT Filed: Nov. 20, 2001
(86) PCT No.: PCT/KR01/01982

(30) Foreign Application Priority Data
May 8, 2001 (KR) KR 2001-13406
Jun. 7, 2001 (KR) KR 2001-16922

(51) Int. Cl. B60J 1/00

(52) U.S. Cl. 296/77.1

(57) ABSTRACT

The present invention relates to a stroller weather shield mounted on the stroller when going out carrying the baby. In order to prevent the fatigue of the eyes and resulting decline of the eyesight of the baby that possibly occur in the convention stroller weather shield, the stroller weather shield according to the present invention is characterized in that said stroller weather shield comprises a body made of at least one material among vinyl, waterproof textile and PVC; and a see-through window having a light transmittance of 85 to 95% and an absolute refraction index of 1.45 to 1.55 in the front upper part of the stroller on which the eyes of the baby in the stroller are concentrated. The stroller weather shield according to the present invention prohibit the baby from directly contacting with the harmful environment, while guiding the eyes of the baby toward the see-through window from the other parts of it having relatively low light transmittance so as to see an object clearly without distortion, whereby the stroller weather shield can remarkably protect the eyesight of the baby by lowering the fatigue of the eyes. Furthermore, the stroller weather shield has the advantage that it is light and easily kept and carried.

### TECHNICAL FIELD

The present invention relates to a stroller weather shield mounted on a stroller when going out carrying a baby, more specifically to a stroller weather shield to protect the eyes of a baby.

### BACKGROUND ART

The stroller weather shield is a structure mounted on the stroller to protect the baby fiom the outside environment of yellow sands, car smokes, other various kinds of floating pollution particles, exterior cold air and so on. The stroller weather shield is comprised of a transparent material so that the baby and its protector each can see the exterior and the interior. The stroller weather shield is made of about 0.2 to 0.5 mm thickness of vinyl sheet made from PVC, PE, and polyurethane. A plural sheet of said material and thickness are sewed up so as to cover the stroller, whereby the stroller weather shield is established.

However, 0.2 to 0.5 mm thickness of vinyl sheets made from PVC, PE, and polyurethane that are usually utilized as a conventional stroller weather shield are remarkably lower in light transmittance compared with plate glass (85%). Furthermore, PVC, PE, polyurethane, etc. made by the blow method are produced by the roller, so that the accuracy of film thickness and the homogeneity of density are lowered due to the limitation of the production process, whereby the random refraction phenomenon occurs as shown in FIG. 1 when the light pass through an inhomogeneous medium. In case of producing the stroller weather shield with said material of vinyl sheets, the partial difference in the thickness and the density on the sheets causes the difference in the refraction angle and the light velocity and wavelength according to the Snell's refraction law (nD=sin i/sin r=v1/v2=λ1/λ2; nD: absolute refraction index, i: incidence angle, v1: light velocity in the medium 1, v2: light velocity in the medium 2), so that the partial refraction indices vary. When the baby look at an object through the stroller weather shield, the differences in the refraction indices disable the baby to focus into one image, so that the object is seen to be distorted. After all, the low transmittance and the random refraction phenomenon not only cause the baby not to see the exterior object clearly, but also cause the image of the object not to be focused into one point on the retina of the baby, so that the shape of the object is seen to be extremely distorted.

Furthermore, the conventional stroller weather shield has the characteristics of being easily wrinkled, so that the phenomenon as if a convex lens and a concave lens crossed occurs. Therefore, the phenomenon like aberration that the focus length becomes shorter or longer or that a straight line is observed to be curved occurs. Namely, the focus locations of the light rays are different on each part of the stroller weather shield, resulting in, for example, a spool type distortion, a barrel type distortion and so on, the phenomena that the image of an object is established not in a flat surface but in a curved surface. FIG. 2a shows a normal image, while FIGS. 2b and 2c show the distortion phenomena due to the aberration. FIG. 2b shows the spool type distortion, while FIG. 2c shows the barrel type distortion.

As described above, each part of the conventional stroller weather shield varies in the diffraction indices due to the characteristics of being easily wrinkled and the inhomogeneity of its light transmittance, density and thickness, so that the distortion of image occurs. Therefore, the baby in the stroller looking at the exterior object experiences the fatigue of the eyes due to the distortion of the objet image, resulting in lowering the eyesight. Even though the baby guardians know said harmful influences, they use the conventional stroller weather shield as it is, because they have no alternatives.

### DISCLOSURE OF THE INVENTION

The present invention is to provide the stroller weather shield that can not only preserve the advantage of protecting the baby in the stroller from the exterior environment but also can remarkably prevent the eyesight decline of the baby by making him see an object without distortion or diffraction.

### BRIEF DESCRIPTION OF THE DRAWINGS

FIG. 1 shows a random refraction phenomenon of light passing through an inhomogeneous medium.

FIG. 2a shows a normal image, while FIGS. 2b and 2c show the distortion phenomena due to the aberration.

FIG. 3 is a perspective view of a stroller mounting the stroller weather shield according to the present invention.

FIG. 4 is an exploded front view of the section “A” in the FIG. 3.

FIGS. 5 and 6 are the drawings for calculating the width and length of the see-through window of the stroller weather shield according to the present invention.

FIG. 7 shows the path of light passing through a uniform medium.

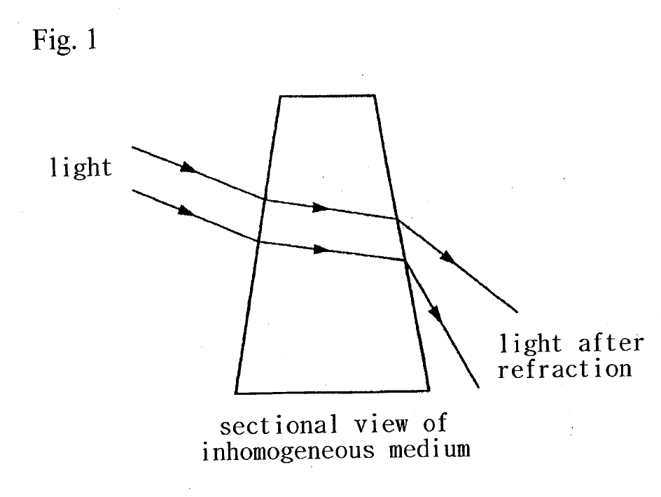

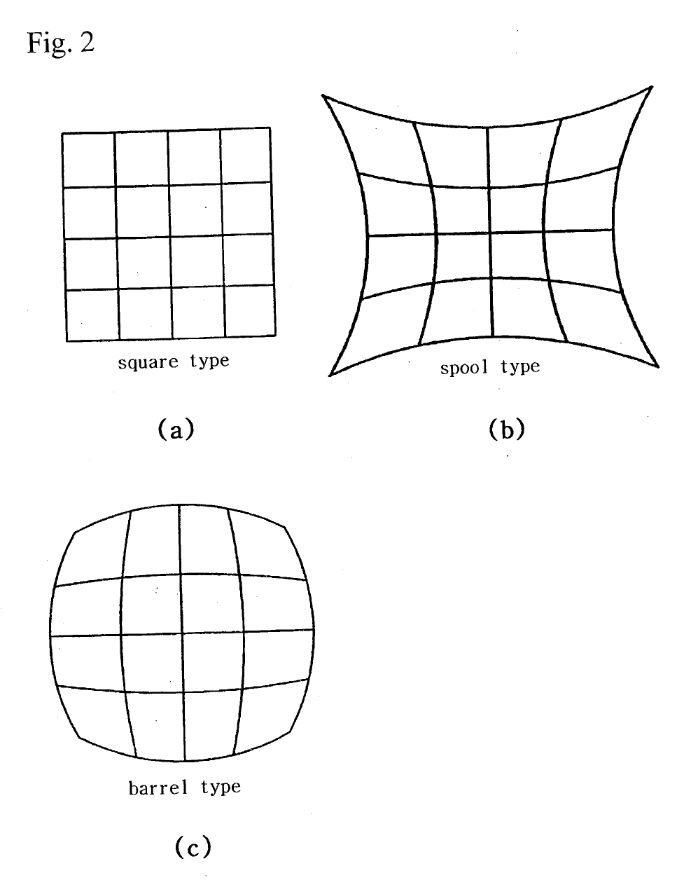

### BEST MODE FOR CARRYING OUT THE INVENTION

The stroller weather shield installed in the stroller according to the present invention to achieve above purpose, is characterized in that said stroller weather shield comprises a body made of at least one material among vinyl, waterproof textile and PVC; and a see-through window having a light transmittance of 85 to 95% and an absolute refraction index of 1.45 to 1.55 in the front upper part of the stroller on which the eyes of the baby in the stroller are concentrated.

In the stroller weather shield according to the present invention, the body of the stroller weather shield can consist of the material selected from PVC, PE, or polyurethane, and the see-through window can consist of PMMA (poly-metyl metha acrylate) resin or polycarbonate whose light transmittance is similar to or superior to the plate glass (85%) and whose unit weight is ½ to ¼ of the plate glass. The PMMA resin has the refraction index of 1.49 and the light transmittance of 92 to 93%, while the polycarbonate has the absolute refraction index (nD) of 1.48 and the light transmittance of 90 to 93%, so that these are lighter in weight, higher in light tramittance, and lower in refraction index than the plate glass. Therefore, the baby in the stroller can see an object without distortion through the see-through window.

On the other hand, the see-through window is combined with the stroller weather shield body usually made of 0.2 to 0.5 mm thickness of PVC, PE or polyurethane by the connection method of ultrasonic compression so that they cannot easily be disconnected by a temperature change or an impact. The see-through windows can also be combined with the body by sewing.

Referring to the drawings, the stroller weather shield according to the present invention will be described in detail below.

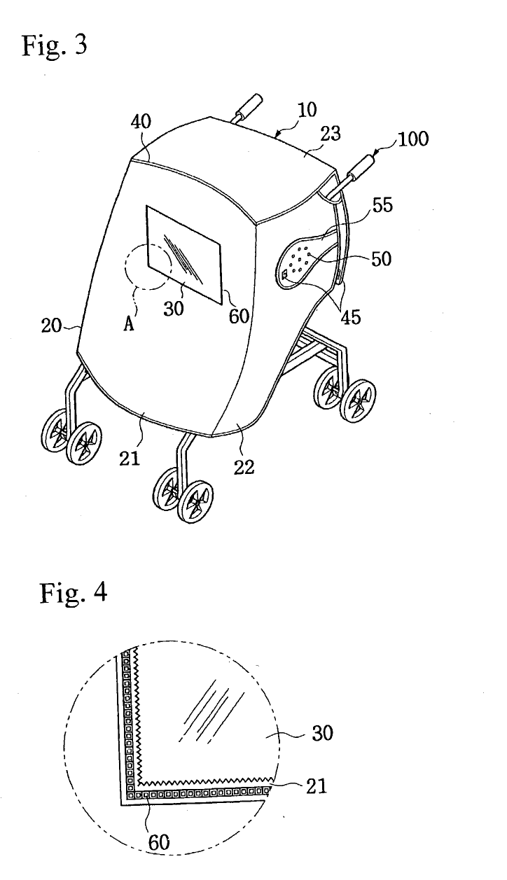

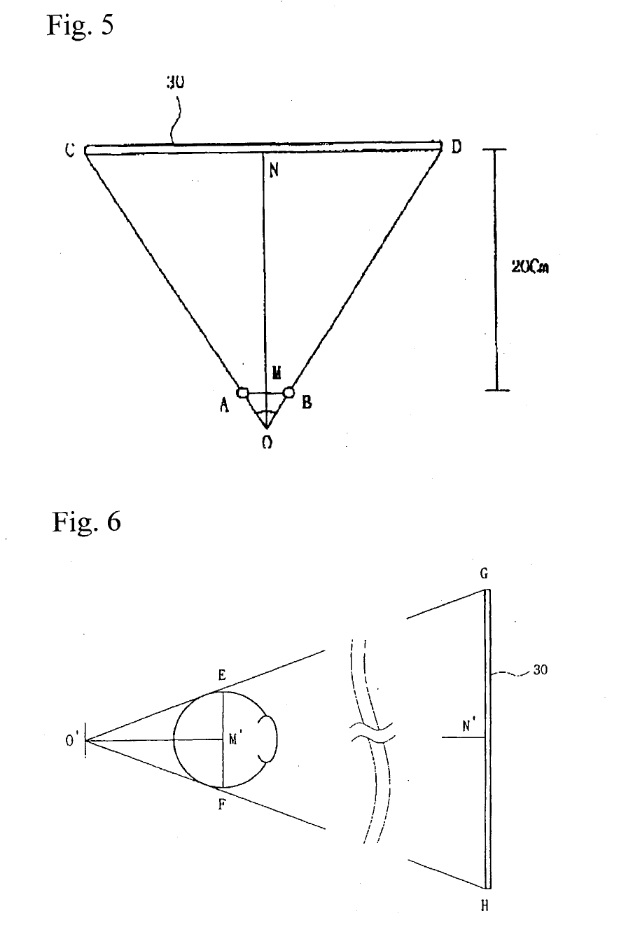

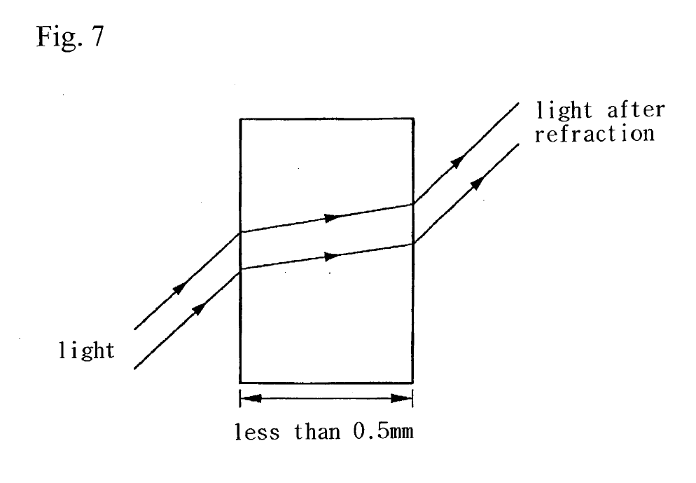

FIG. 3 is a perspective view of a stroller mounting the stroller weather shield according to the present invention. FIG. 4 is an exploded front view of the section “A” in the FIG. 3. FIGS. 5 and 6 are the drawings for calculating the width and length of the see-through window of the stroller weather shield according to the present invention. FIG. 7 shows the path of light passing through a uniform medium.

Referring to FIGS. 3 and 4, the stroller weather shield (10) according to the present invention for the baby to see an object without distortion while protecting the baby from the harmful environment such as polluted air, dusts, rain, wind, pollen, etc. comprises a stroller weather shield body (20) and a see-through window (30). A front vinyl part (21), two side vinyl parts (22), and a top vinyl part (23) are combined by some lengths of sewing parts (40) to form the stroller weather shield body (20) so that the stroller (100) can be covered with it. The side vinyl parts (22) and the top vinyl part (23) are each formed so as to be extended longer than the sides and the top of the stroller (100), and the adhesive non-woven fabrics are each formed at the predetermined positions on the portions of the extended sewing parts. The adhesive non-woven fabrics of the extended portions of two side vinyl parts (22) are combined each other, and the adhesive non-woven fabrics of the extended portions of the top vinyl part (23) are combined with another adhesive non-woven fabrics (not shown) formed on the extended portions of two side vinyl parts, whereby they are installed in the stroller. Meanwhile, a ventilation (50) formed with multiple holes is provided on upper portion of each side vinyl part (22), and one side part of a ventilation cover (55) veiling the ventilation (50) is fixed to the sewing parts (40). An adhesive non-woven fabric (not shown) is also combined with the interior surface of the ventilation cover (55), and another non-woven fabric (not shown) is also combined at the position corresponding to it.

Herein, each vinyl part (21,22,23) forming the stroller weather shield body (20) is 0.2 to 0.5 mm thickness-of vinyl material having excellent ductility such as PVC, PE, or polyurethane that are generally used as the stroller weather shield. Besides the vinyl, waterproof fabric sheets can also be used.

A see-through window (30) is formed at the center of the upper portion of a front vinyl part (21) on which the eyes of the baby in the stroller are most concentrated. The see-through window (30) utilizes a fixation that occurs to 5 to 6 month baby, namely, a kind of reflex action that the baby moves the eyes toward the direction that can make the baby see an object most clearly. The see-through window (30) is formed to provide more than least size that is required for a visual field of the baby, on the basis of general visual angle of both eyes (about 60° from the center), distance between both eyes (about 5 cm), distance from both-eyes to the stroller weather shield (about 20 cm), distance from both eyes to the center of their fossae axes (about 4 cm), and thicknesses of eyeballs (about 2.5 cm).

Referring to FIG. 5, the most general size of the see-through window (30) that is required for the eyesight of the baby will be calculated below. The visual angle of the baby is usually about 60° from the center. The distance between both eyes (AB) is 5 cm on average. The distance from the point (M) to the see-through window (30) (the distance from both eyes of the baby to the stroller weather shield) is about 20 cm. Therefore, the vertical length (OM) from the center of the visual field (O) to both eyes is about 4.3 cm, since the angle (AOM) is 30° in the triangle (OAM), and the value of tan 30° (2.5 cm/OM) is about 0.578. According to the symmetry, OM:ON=AB:CD is 4.3:24.3=5:CD. Therefore, the horizontal length (CD) of the see-through window (30) is about 28 cm. Furthermore, since the diameter of the baby's eyeball is usually 2.5 cm, as shown in FIG. 6, substituting 4.3 cm (the distance from the center of the visual field (O′) to both eyes) into the symmetry equation (in this case, O′M′:EF=O′N′:GH) result in 4.3:2.5=24.3:GH. Therefore, the vertical length (GH) of the see-through window (30) is about 15 cm. After all, the size of see-through window (30) that is required for the visual field of the baby should be horizontally more than about 28 cm and vertically more than about 15 cm.

Additionally, the see-through window (30) is made of PMMA resin (absolute refraction index: 1.49, light transmittance: 92-93%, specific gravity: 1.2) or polycarbonate (absolute refraction index: 1.48, light transmittance: 90-93%, specific gravity: 1.2) that is similar in flatness and superior in refraction index compared with the plate glass (absolute refraction index: 1.5, light transmittance: 85%) and that has a unit weight of ½ to ¼ of plate glass. However, without limit to those described above, any material can be adopted that has the light transmittance of more than 90% (superior to plate glass), the absolute refraction index of 0.145 to 1.55 (similar to plate glass), and the specific gravity of less than 1.2.

Herein, the see-through window (30) is joined by ultrasonic compression to form an ultrasonic compression part (60) so that it cannot easily be disconnected by a temperature change or an impact. However, without limit to those described above, it can also be joined by sewing, or can be detachably connected by the adhesive non-woven fabrics, etc.

As described in the above embodiments, the stroller weather shield according to the present invention is provided with the see-through window made from PMMA or polycarbonate whose light transmittance is more than 90% in the front upper part of the stroller weather shield on which the eyes of the baby in the stroller are concentrated. Said see-through window can provide the baby in the stroller with more clear visual field than the conventional window made of the plate glass can do. Also, said see-through window can maintain the uniform refraction index as shown in FIG. 7 owing to the flatness by the high rigidity and owing to the homogeneity of density and thickness. Therefore, an object through the see-through window can be seen more clearly without distortion. In particular, the parallel shifting of image, namely, the general phenomenon according to the Snell's law when an object is seen through the see-through window, is minimized so as not to be sensed, whereby there is hardly any difference in the images at the retina when the baby looks at the object without the stroller weather shield and when the baby looks at it through the stroller weather shield. When the baby looks at an object via the see-through window from the interior to the exterior of the stroller weather shield, the baby feels as if he looks forward through a window in a car. Furthermore, PMMA or polycarbonate that is the material of the see-through window is rigid enough to maintain the flatness.

Additionally, the stroller weather shield according to the present invention has the see-through window of less than 0.5 mm in thickness, so that the see-through window makes little effect on the overall weight of the stroller weather shield. Also, the see-through window is formed with a minimum size that can provide the visual field needed for the baby, whereby the other parts can easily be folded toward the see-through window along the boundary so that there are no difficulties in keeping or carrying it.

As described above, the stroller weather shield according to the present invention prohibit the baby from directly contacting with the harmful environment, while guiding the eyes of the baby toward the see-through window from the other parts of it having relatively low light transmittance so as to see an object clearly without distortion, whereby the stroller weather shield can remarkably protect the eyesight of the baby by lowering the fatigue of the eyes. Furthermore, the stroller weather shield has the advantage that it is light and easily kept and carried.

What is claimed is:

1. A stroller weather shield installed in a stroller, characterized in that said stroller weather shield comprises:
a stroller weather shield body made of at least one material among vinyl, waterproof textile and PVC; and
a see-through window having a light transmittance of 85 to 95% and an absolute refraction index of 1.45 to 1.55 in the front upper part of the stroller on which the eyes of the baby in the stroller are concentrated.

2. A stroller weather shield according to claim 1, characterized in that said see-through window has the width of about 28 cm and the length of about 15 cm.

3. A stroller weather shield according to claim 1, characterized in that said see-through window is of the material of either PMMA resin or polycarbonate.

4. A stroller weather shield according to claim 1, characterized in that said see-through window has the thickness of 0.2 to 0.5 mm.

5. A stroller weather shield according to claim 1, characterized in that said see-through window is connected to said stroller weather shield body by ultrasonic compression method.

6. A stroller weather shield according to claim 1, characterized in that said see-through window is connected to said stroller weather shield body by sewing.

7. A stroller weather shield according to claim 1, characterized in that said see-through window is detachably connected to said stroller weather shield body.
